(19) United States
(12) Patent Application Publication
(10) Pub. No.: US 2008/0186278 A1
(43) Pub. Date: Aug. 7, 2008

(54) Mouse capable of measuring vital signs of a user manipulating same

(76) Inventor: Kent T.J. Hsu, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/700,962

(22) Filed: Feb. 1, 2007

(51) Int. Cl. G06F 3/033

(52) U.S. Cl. 345/163; 73/700

(57) ABSTRACT

A system includes a mouse pad, a mouse including a display, a circuitry including a display circuit, a first amplification circuit, an inflation control circuit, a control IC, an ADC, and a second amplification circuit, a first measurement device, and a second measurement device; and a band assembly including a manometer, an air pump, and an inflatable band. In response to wrapping the band around the wrist of a user holding the mouse, the second measurement device measures pulse and sends same to the control IC; the manometer measures blood pressure and sends same to the control IC; the first measurement device measures body temperature and total calories by contacting the hand and sends same to the control IC; and the control IC sends the signals to the display circuit for processing into data representing blood pressure, pulse, body temperature, and total calories which are sent to the display.

### BACKGROUND OF THE INVENTION

1. Field of Invention

The invention relates to computer mouse and more particularly to such a mouse capable of measuring vital signs including body temperature, pulse, blood pressure, and total calories of a user manipulating same.

2. Description of Related Art

There is a rapid, spectacular development of information technology in these several years. Further, people heavily rely on computers in processing data and exchanging information with other people in their daily life. Thus, computers have become a ubiquitous tool for both personal and work related tasks. Typically, a personal computer is equipped with a mouse as shown in FIG. 1. A mouse is a hand-held input device which is the only function thereof. Thus, continuing improvements in the exploitation of mouse capable of measuring vital signs including body temperature, pulse, blood pressure, and total calories of a user manipulating same are being sought.

### SUMMARY OF THE INVENTION

It is therefore one object of the invention to provide a measurement system for use with a computer having a monitor, comprising a mouse pad; a mouse fixedly mounted on the mouse pad and including a cord attached to one end, a surface display, a circuitry including a display circuit, a first amplification circuit, an inflation control circuit, a control IC, a plurality of pins for setting, an ADC, and a second amplification circuit, a surface first measurement device, and a surface second measurement device; and a band assembly fixedly mounted on the mouse pad and spaced from the other end of the mouse, the band assembly including a manometer, an air pump, and an inflatable band; wherein in response to wrapping the band around the wrist of a user holding the mouse by the hand, (i) the second measurement device is adapted to measure rate and force of pulse of the user, the measured value is converted into a first signal which is sent to the first amplification circuit for amplification, and the amplified first signal is sent to the control IC; (ii) the manometer is adapted to generate a second signal in response to contacting the wrist, the second signal is sent to the second amplification circuit for amplification, the amplified second signal is sent to the ADC for converting into a first digital signal, the first digital signal is sent to the control IC, the control IC is adapted to generate a third signal to the inflation control circuit, the inflation control circuit is enabled to generate a fourth signal to activate the air pump to inflate the band for compressing the wrist, and enable the manometer to measure blood pressure of the user, the measured blood pressure is converted into a fifth signal which is sent to the second amplification circuit for amplification, the amplified fifth signal is sent to the ADC for converting into a second digital signal, and the second digital signal is sent to the control IC; (iii) the first measurement device is adapted to measure body temperature and total calories of the user in response to contacting the hand, the measured body temperature and the measured total calories are converted into a sixth signal which is sent to the second amplification circuit for amplification, the amplified sixth signal is sent to the ADC for converting into a third digital signal, and the third digital signal is sent to the control IC; and (iv) in response to receiving the signals, the control IC sends same to the display circuit for processing into corresponding data representing the blood pressure, the pulse, the body temperature, and the total calories of the user which are sent to the display for display.

In one aspect of the invention in response to receiving the signals, the control IC sends same in the form of digital values of the blood pressure, the pulse, the body temperature, and the total calories to the monitor via the cord and the computer for display.

The above and other objects, features and advantages of the invention will become apparent from the following detailed description taken with the accompanying drawings.

### BRIEF DESCRIPTION OF THE DRAWINGS

FIG. 1 is a top view of a conventional mouse;

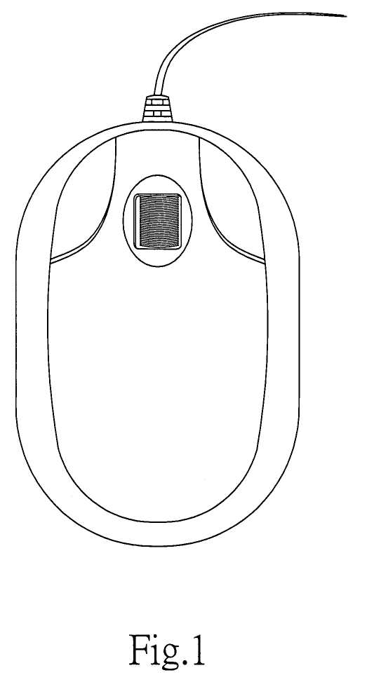

FIG. 2 is a schematic perspective view of a preferred embodiment of mouse and wrist band assembly according to the invention;

FIG. 3 is a schematic environmental view of the mouse being operated by a user having the wrist being wrapped around by the wrist band with values of body temperature, pulse, blood pressure, and total calories being shown on a computer monitor; and

FIG. 4 is a circuit block diagram of the wrist band assembly and a part of the mouse forming the system for measuring vital signs of the user.

### DETAILED DESCRIPTION OF THE INVENTION

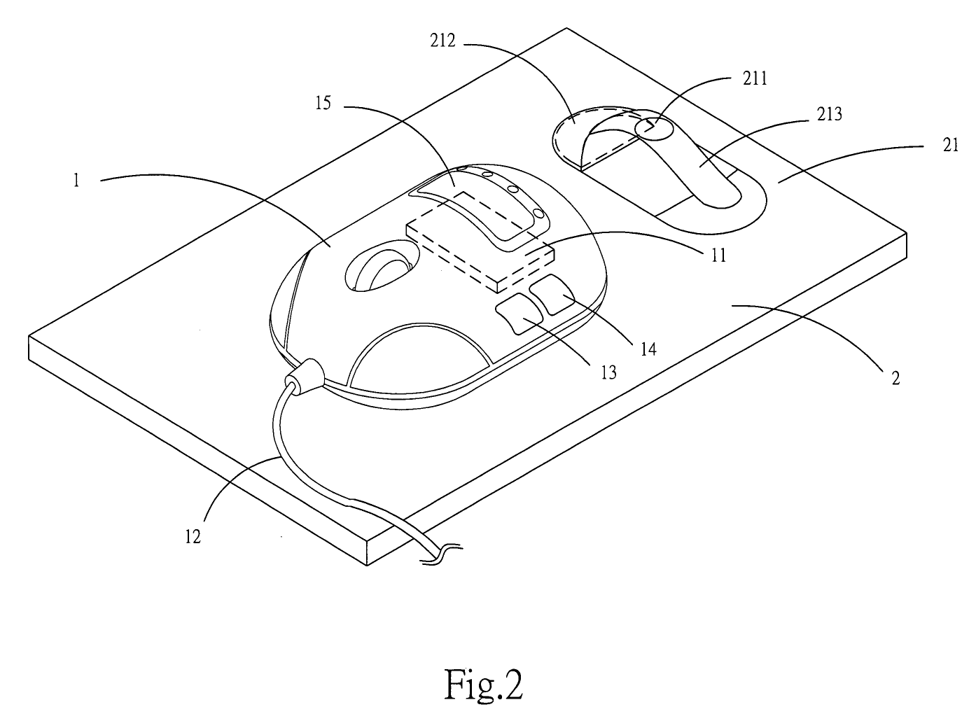

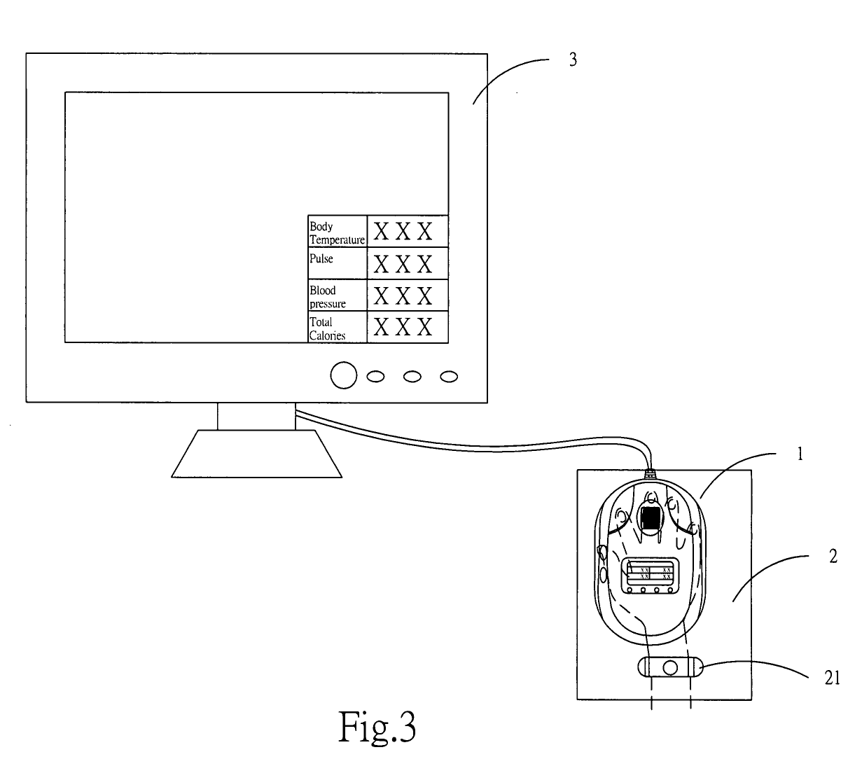

Referring to FIGS. 2 and 3, a system for measuring vital signs including body temperature, pulse, blood pressure, and total calories of a user operating a mouse in accordance with a preferred embodiment of the invention is shown. The system comprises a mouse 1 and a wrist band assembly 21 both fixedly mounted on a mouse pad 2.

The mouse 1 comprises a cord 12 attached to one end, a surface display 15, an internal circuit board 11 with circuitry required by the system mounted thereon, a first measurement device 13 at one side, and a second measurement device 14 adjacent the first measurement device 13. The first measurement device 13 is implemented as both clinical thermometer and calorimeter. The second measurement device 14 is implemented as a pulsimeter.

The wrist band assembly 21 is implemented as a sphygmomanometer and comprises a manometer 211, an air pump 212, and an inflatable wrist band 213. The wrist band assembly 21 is aligned with and spaced from the other end of the mouse 1. In operation the wrist of a user is wrapped around by the wrist band 213. Further, the hand contacts both the first and second measurement devices 13 and 14.

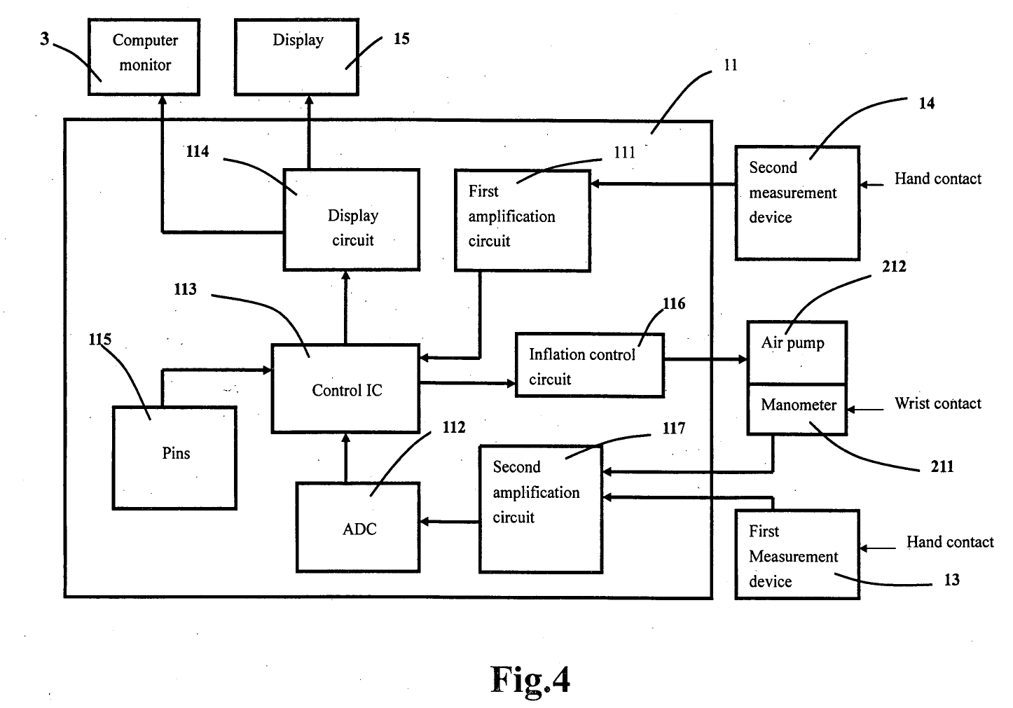

Referring to FIG. 4 in conjunction with FIGS. 2 and 3, an operation of the invention will be described in detailed below.

(i) The second measurement device 14 is adapted to measure pulse of the user. The measured pulse is converted into a first signal which is in turn sent to a first amplification circuit 111 for amplification. The amplified first signal is then sent to a control integrated circuit (IC) 113.

(ii) The manometer 211 is adapted to generate a second signal in response to contacting the wrist. The second signal is in turn sent to a second amplification circuit 117 for amplification. The amplified second signal is then sent to an ADC (analog to digital converter) 112 for converting into a first digital signal. The first digital signal is then sent to the control IC 113. And in turn, the control IC 113 generates a third signal to an inflation control circuit 116. The inflation control circuit 116 is enabled to generate a fourth signal and send same to the air pump 212 for activating the air pump 212 to inflate the wrist band 213 to compress the wrist. Also, the manometer 211 is enabled to measure blood pressure. The measured blood pressure is converted into a fifth signal which is in turn sent to the second amplification circuit 117 for amplification. The amplified fifth signal is then sent to the ADC 112 for converting into a second digital signal. The second digital signal is then sent to the control IC 113.

(iii) The first measurement device 13 is adapted to measure both body temperature and total calories in response to contacting the hand of the user. The measured body temperature and total calories are converted into a sixth signal which is in turn sent to the second amplification circuit 117 for amplification. The amplified sixth signal is then sent to the ADC 112 for converting into a third digital signal. The third digital signal is then sent to the control IC 113.

(iv) After receiving the above signals, the control IC 113 may either in a first configuration send same to a display circuit 114 for processing into corresponding data representing the above vital signs including blood pressure, pulse, body temperature, and total calories which are then sent to a display 115 for display or in a second configuration send same directly to a monitor 3 of computer (not shown) via the cord 12 and the computer for displaying the above vital signs including blood pressure, pulse, body temperature, and total calories.

On the circuit board 11 there are further provided a plurality of pins 115 for setting purpose.

While the invention herein disclosed has been described by means of specific embodiments, numerous modifications and variations could be made thereto by those skilled in the art without departing from the scope and spirit of the invention set forth in the claims.

What is claimed is:

1. A measurement system for use with a computer having a monitor, comprising:
a mouse pad;
a mouse fixedly mounted on the mouse pad and including a cord attached to one end, a surface display, a circuitry including a display circuit, a first amplification circuit, an inflation control circuit, a control IC, an ADC, and a second amplification circuit, a surface first measurement device, and a surface second measurement device; and
a band assembly fixedly mounted on the mouse pad and spaced from the other end of the mouse, the band assembly including a manometer, an air pump, and an inflatable band;
wherein in response to wrapping the band around the wrist of a user holding the mouse by the hand, (i) the second measurement device is adapted to measure rate and force of pulse of the user, the measured value is converted into a first signal which is sent to the first amplification circuit for amplification, and the amplified first signal is sent to the control IC; (ii) the manometer is adapted to generate a second signal in response to contacting the wrist, the second signal is sent to the second amplification circuit for amplification, the amplified second signal is sent to the ADC for converting into a first digital signal, the first digital signal is sent to the control IC, the control IC is adapted to generate a third signal to the inflation control circuit, the inflation control circuit is enabled to generate a fourth signal to activate the air pump to inflate the band for compressing the wrist, and enable the manometer to measure blood pressure of the user, the measured blood pressure is converted into a fifth signal which is sent to the second amplification circuit for amplification, the amplified fifth signal is sent to the ADC for converting into a second digital signal, and the second digital signal is sent to the control IC; (iii) the first measurement device is adapted to measure body temperature and total calories of the user in response to contacting the hand, the measured body temperature and the measured total calories are converted into a sixth signal which is sent to the second amplification circuit for amplification, the amplified sixth signal is sent to the ADC for converting into a third digital signal, and the third digital signal is sent to the control IC; and (iv) in response to receiving the signals, the control IC sends same to the display circuit for processing into corresponding data representing the blood pressure, the pulse, the body temperature, and the total calories of the user which are sent to the display for display.

2. The mouse of claim 1, wherein in response to receiving the signals, the control IC sends same in the form of digital values of the blood pressure, the pulse, the body temperature, and the total calories to the monitor via the cord and the computer for display.

3. The mouse of claim 1, wherein the first measurement device is served as a clinical thermometer and a calorimeter.

4. The mouse of claim 1, wherein the second measurement device is a pulsimeter.
